(19) United States
(12) Patent Application Publication
(10) Pub. No.: US 2002/0194769 A1
(43) Pub. Date: Dec. 26, 2002

(54) Fish hook tote

(76) Inventors: Randolph Wicker, Huntersville, NC (US); Mabel Wicker, Huntersville, NC (US)

Correspondence Address: Charles Y. Lackey, Post Office Box 5871, Winston-Salem, NC, 27113-5871, US

(21) Appl. No.: 09/740,673

(22) Filed: Dec. 18, 2000

(51) Int. Cl. A01K 87/00

(52) U.S. Cl. 43/25.2

(57) ABSTRACT

A fishing hook and lure carrier that holds a fishing hook and line in close proximity to the shaft of a fishing rod. The fishing hook and lure carrier employs a pair of interior mating surfaces to internally secure hooks and lures and another pair of mating surfaces to secure the carrier to the shaft of a fishing rod. The fishing hook tote of the present invention eliminates the snaring of clothing and other fabrics by potentially harmful fishing hooks.

### BACKGROUND OF THE INVENTION

1. Field of the Invention

The present invention relates generally to fishing hook and lure carriers and more particularly, to a soft, flexible hook and lure carrier that holds a hook and line close to a fishing pole.

2. Description of Related Art

In the popular sport of fishing care must be taken to ensure that a fishing sportsman is not accidentally snared by a fishing hook. Avoidance maneuvers by the fishing sportsman may not prevent a fishing hook from being caught in clothing or the skin. Thus, the safe handling of fishing gear can be tenuous. In addition, the untangling of tangled fishing lines is time-consuming and tedious with the untangling process becoming expensive if the tangled lines must be cut and replaced.

The prior art describes a variety of carriers used to hold fishing hooks and lures. For example, a shield for fish hooks is described in U.S. Pat. No. 3,940,873 issued on Mar. 2, 1976 to E. E. Lawless. The fish hook shield consists of two mating body portions joined together along facing edges by an integral hinge. The free end of each body portion is provided with a tab-like projection which may be grasped by the fingers of the user to facilitate unfolding of the shield.

U.S. Pat. No. 5,131,180 issued on Jul. 21, 1992 to A. Ives describes a lure and hook safety device. The safety device is a fishing safety pouch that secures the lure and hooks of a fishing rod in a protected position. The fishing safety pouch consists of a tough, non-abradable fabric having inner and outer surfaces defining a hollow envelope. A fishing lure wrap is described in U.S. Pat. No. 5,598,658 issued on Feb. 4, 1997 to W. M. Walker. The fishing lure wrap is used to secure a lure and consists of a soft pliable material.

None of the above inventions and patents, taken either singly or in combination, is seen to describe the instant invention as claimed.

### SUMMARY OF THE INVENTION

The present invention is a fishing hook and lure carrier, having a soft, flexible enclosure that is both tough and durable. The hook and lure carrier of the present invention employs interior mating surfaces of a hook and loop fastening material and exterior mating surfaces of a hook and loop fastening material. The interior hook and loop mating surfaces secure hooks, lures, and the like while the mating surfaces secures the carrier to the shaft of a fishing rod. Therefore, the fishing hook tote of the prevent invention eliminates the possibility of fishing hooks getting caught in a person's clothes or in the vehicle's interior fabric.

The fishing hook tote prevents fishing lines from becoming tangled when more than one fishing rod is stored or transported.

The fishing hook tote also prevents the hooks, lures, and lines of multiple line fishing rods from being tangled. Furthermore, the fishing hook tote maintains a fishing line in a taut condition thereby preventing fouling of the fishing line while the fishing rod is carried.

Accordingly, it is a principal object of the invention to provide a fishing hook tote that is easy and convenient to use.

It is another object of the invention to provide a fishing hook tote that is easy to open and close.

It is a further object of the invention to provide a fishing hook tote that secures a fishing hook or lure in close proximity to the shaft of a fishing rod.

Still another object of the invention is to provide a fishing hook tote that eliminates the time-consuming and costly tangling of fishing lines and hooks.

Another object of the invention to provide improved elements and arrangements thereof in a fishing hook tote for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental view of a fishing hook tote securing a fishing hook and line to a fishing rod according to the present invention.

FIG. 2 is a front view of the interior of a fishing hook tote showing the arrangement of the interior fastening material.

FIG. 3A is a front view of a partially folded fishing hook tote showing the arrangement of the exterior fastening material.

FIG. 3B is a front view of a completely closed fishing hook tote.

Similar reference characters denote corresponding features consistently throughout the attached drawings.

### DETAILED DESCRIPTION OF THE PREFERRED EMBODIMENTS

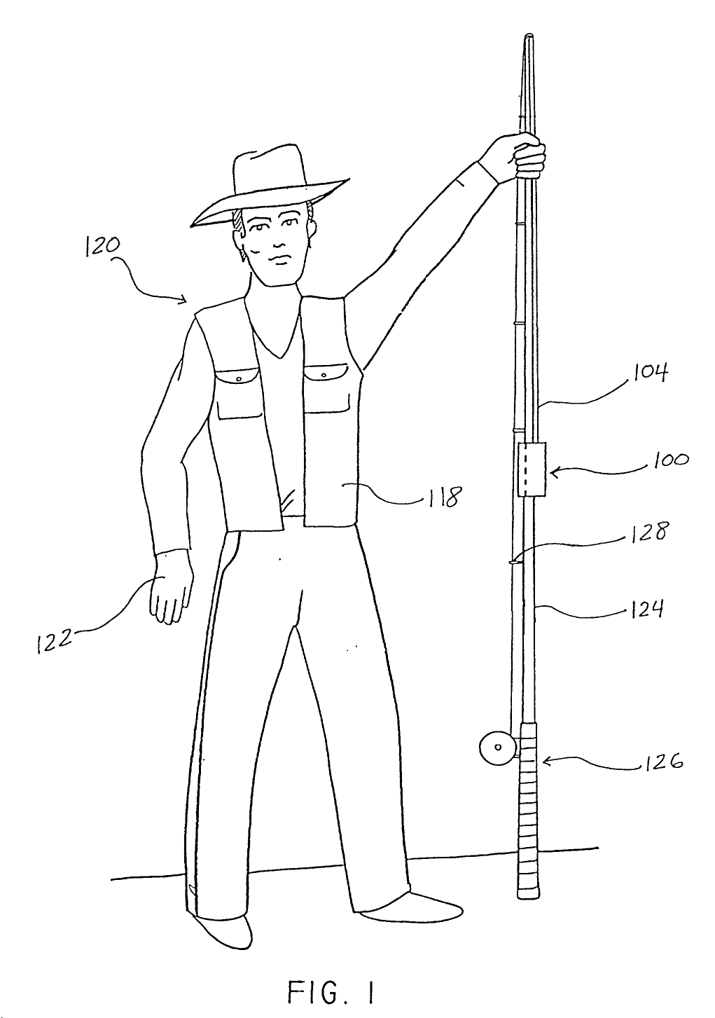

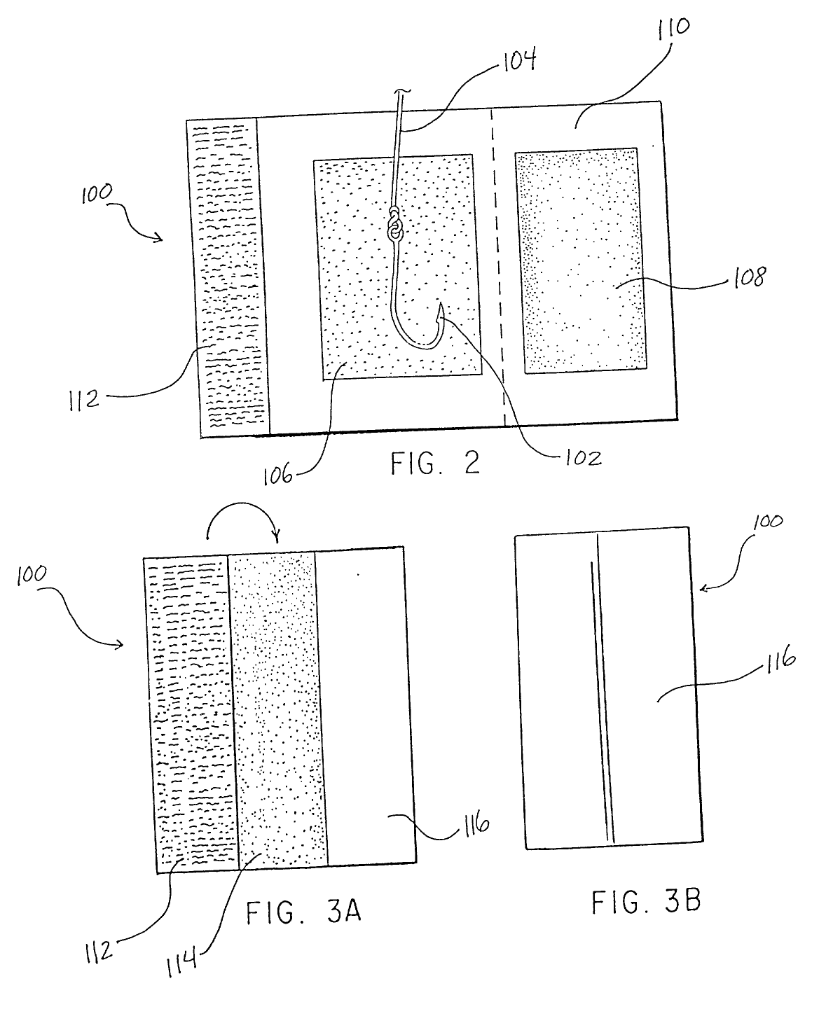

The present invention, as depicted in FIGS. 1-4, is a fishing hook and lure carrier 100 that secures and protects fishing hooks 102 and lures (not shown) while simultaneously maintaining a fishing line 104 in a taut condition. FIG. 1 is an environmental view of a fishing hook tote 100 securing a fishing hook 102 (see FIG. 2) and line 104 to a fishing rod 126. The fishing hook tote 100 secures a hook 102 or lure (not shown) in close proximity to the shaft 124 of a fishing rod 126. The mating surfaces 112, 114 (see FIG. 2) of fastening material such as VELCRO are used to attach the tote or carrier 100 to the shaft 124 of the fishing rod 126 while the interior mating surfaces 106, 108 of fastening material secure the fishing hook 102 and the fishing line 104. Therefore, the fishing hook tote or carrier 106 eliminates the possibility of a fishing hook 102 accidentally snaring the clothing 118 or the skin 122 of a fishing sportsman 120 or anyone else nearby.

In addition, the fishing hook tote 100 holds a fishing line 104 in a taut condition which prevents fouling of the fishing line 104 while the fishing rod 126 is being carried by the fishing sportsman 120. The fishing hook tote 100 also reduces the pressure on the line guides 128 of the fishing rod 126 which prevents the fishing rod 126 from developing a permanent bow.

The fishing hook tote 100 prevents the hooks 102, lures, and lines 104 of multiple line fishing rods (not shown) from becoming tangled which saves time, money, and effort. The untangling of tangled fishing lines 104 is tedious and time-consuming with the untangling process becoming expensive if the tangled lines 104 must be cut and replaced with new lines.

FIG. 2 is a front view of the interior of a fishing hook tote 100 showing the arrangement of the interior fastening material 106, 108. The fastening material can be a hook and loop material such as VELCRO, however, any appropriate fastening material can be used. In a preferred embodiment, the fishing hook tote 100 is approximately 5½ inches in length and approximately 4½ inches width. The interior fastening material mating surfaces 106, 108 are rectangular in shape and are approximately 2 inches wide and 1½ inches in length. The interior surface 110 of the fishing hook tote 100 can be made of any suitable material, for example, a cloth. The exterior fastening material mating surfaces 112, 114 are in the shapes of elongated rectangular strips that are approximately 4½ inches in length and approximately 1 inch in width.

When the fishing hook tote 100 is completely open as depicted in FIG. 2, the interior fastening material mating surfaces 106, 108 and one fastening material mating surface. are aligned as shown in FIG. 1. A fishing hook 102 or lure is placed on the centrally disposed interior piece of fastening material 106 as shown in FIG. 2. The corresponding interior mating surface of fastening material 108 is folded over onto the interior piece of fastening material 106 onto which the fishing hook 102 or lure were placed thereby safely enclosing the fishing hook 102 or lure. Although FIG. 2 shows a single fishing hook 102, the fishing hook tote 100 can hold several fishing hooks 102 and/or lures.

Now the fishing hook tote 100 is partially closed as depicted in FIG. 3A which is a front view of a partially folded fishing hook tote 100 showing the arrangement of the fastening material 112, 114. The laterally disposed piece of fastening material 112 is folded over onto the mating surface of fastening material 114 thereby enclosing the fishing hook 102 or lure, the fishing line 104, and a portion of the shaft 124 of the fishing rod 126. FIG. 3b is a front view of a completely closed fishing hook tote. The exterior surface 116 of the fishing hook tote 100, made of any suitable material, for example, a plastic such as vinyl.

The fishing hook tote of the present invention eliminates the pain, suffering, and medical expense associated with having to remove a fishing hook from a child or an adult. The fishing hook tote is inexpensive to produce and can be made by conventionally known methods of manufacture.

The preferred embodiments of the present invention disclosed herein are intended to be illustrative only and are not intended to limit the scope of the invention. It should be understood by those skilled in the art that various modifications and adaptations of the present invention as well as alternative embodiments of the present invention may be contemplated.

It is to be understood that the present invention is not limited to the embodiments described above, but encompasses any and all embodiments within the scope of the following claims.

We claim:

1. A fishing hook and lure carrier for securing one or more hooks or lures in close proximity to the shaft of a fishing rod comprising:
a flexible material segment having an interior surface and an exterior surface;
three pieces of fastening material on the interior surface of said flexible material segment; and
a single piece of fastening material on the exterior surface of said flexible material segment;
the flexible material segment folding upon itself and enclosing at least the fishing hook between two of the three, interior surface fastening material pieces, and overlapping itself about the fishing rod so that the remaining piece of the three interior surface fastening material pieces is engaged by and: releasably secured to the exterior surface fastening piece.

2. A fishing hook and lure carrier according to claim 1, said fastening material segment having a rectangular configuration.

3. A fishing hook and lure carrier according to claim 1, wherein at least one of the interior fastening material pieces has a rectangular configuration.

4. A fishing hook and lure carrier according to claim 3, said exterior fastening material piece having an elongated rectangular configuration.

5. A fishing hook and lure carrier according to claim 4, said fastening material segment having a rectangular configuration.

6. A fishing hook and lure carrier according to claim 1, said exterior fastening material piece having an elongated rectangular configuration.

7. A fishing hook and lure carrier according to claim 1, said flexible material segment having a rectangular configuration.

8. A fishing hook and lure carrier according to claim 5, said flexible material segment having a rectangular configuration.
